(19) United States
(12) Patent Application Publication
(10) Pub. No.: US 2003/0125816 A1
(43) Pub. Date: Jul. 3, 2003

(54) Backtracking resources planning algorithm

(76) Inventors: Blair Daniel Leduc, Mount Hope (CA); Michael Macalister Peck, Toronto (CA); Pamela Ann Marie Renton, Hamilton (CA)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/286,273

(22) Filed: Oct. 31, 2002

Related U.S. Application Data
(60) Provisional application No. 60/330,826, filed on Oct. 31, 2001.

(51) Int. Cl. G05B 11/01

(52) U.S. Cl. 700/17

(57) ABSTRACT

A method of scheduling a plurality of tasks includes the steps of establishing a node representative of each task, and indicative of resources required to perform that task. A hierarchy is established between the nodes to indicate an order in which tasks represented by the node are to be performed. The nodes whose hierarchy permits tasks represented by the node to be performed are selected to a next nodes list. A source is assigned to each of the selected nodes and is indicative of a priority to be accorded to respective ones of the selected nodes. The node with the highest priority is scheduled.

### CROSS-REFERENCE TO RELATED APPLICATION

This application claims the benefit of U.S. application Ser. No. 60/330,826, which is hereby incorporated by reference as though fully set forth herein.

### FIELD OF THE INVENTION

The present invention relates to a resource allocation method and system for creating fault-tolerant plans through backtracking. It has particular utility in, but is not limited to, scheduling of robotic devices to perform repetitive tasks.

### BACKGROUND OF THE INVENTION

Robotic devices are used to perform repetitive tasks in a number of environments such as assembly line and laboratories. In a laboratory setting, a user typically describes a sequence of steps to be performed on a set of microplates, including the number of times that particular sequence is to be repeated. As each repetition operates on a separate set of microplates, then each set of microplates is independent, yet their processing depends on a limited set of resources that must be shared. In the context of a laboratory, these resources are typically instruments to monitor or assess a sample, a dispenser to supply a fluid or an incubator in which samples are placed for a period of time. The challenge is to assign resources to steps such that the resources are not over allocated and the steps are executed in the correct order. Other additional restrictions may apply, for instance, restrictions can be specified between steps in a sequence, and to limit the time elapsed between the steps.

Several algorithms have been proposed to solve this problem, but most have disadvantages such as lack of speed on large scheduling problems and a propensity to get stuck in logjam conditions. Generally, they are grouped into two classes. Static algorithms compute a sequence of steps prior to the system executing. Dynamic algorithms compute the steps during the run.

Static algorithms which do not include the ability to backtrack require that each decision be carefully considered, thus making such solutions slow. Generally, a perfect decision cannot be made. Depending on the implementation, certain problem classes exist which will lead the algorithm to a logjam conditions. If the algorithm has no backtracking facility, the scheduler fails.

Dynamic algorithms result in less optimal system throughput, due to the need to make immediate decisions that cannot be considered long enough to ensure their quality. Furthermore, these systems are not tolerant of code bugs and logjam conditions, due to the fact that errors at run time result in incomplete runs instead of mere scheduling failures.

Backtracking has long been used as a strategy for solving combinatorial problems. Backtracking algorithms are widely used, especially on Np Complete problems. In order to make these algorithms computationally feasible on a range of large problems, they are usually tailored to particular applications. A backtracking algorithm entails constructing a partial solution (a subset of variables) that satisfies all of the constraints within the subset, expanding the partial solution by adding new variables one by one, and if no value satisfies the constraints within the partial solution, the most recently added variable value is changed.

A backtracking algorithm may also be regarded as a tree-spanning algorithm, since when a node with more than one path to choose from is reached, a leaf node or a dead node may be chosen. Should it be impossible proceed any more, the algorithm unwinds to its previous execution, and takes an alternate path. Such an algorithm is known as a depth-first spanning algorithm, because it tends to follow a path right down to the bottom of the tree, before it gives up and unwinds to a previous execution in order to choose a different path. Thus, backtracking procedures are characterized by multiple recursive calls, typically within a loop.

### SUMMARY OF THE INVENTION

In one aspect the invention provides a resource allocation method and system for the creation of fault-tolerant plans through backtracking. The method and system includes a backtracking algorithm which has been adapted to track the position of containers, and the usage of resources which are required to store and move said containers.

### BRIEF DESCRIPTION OF THE DRAWINGS

These and other features of the preferred embodiments of the invention will become more apparent in the following detailed description in which reference is made to the appended drawings wherein:

FIG. 1 shows a schematic of a typical laboratory apparatus in which the algorithm can be used;

FIG. 2a-FIG. 2m illustrate schematically the iterations of the scheduling algorithm used to perform a sequence of operations on the apparatus of FIG. 1;

FIG. 3 shows a graphical time sequence chart similar to a Gantt type chart of the tasks scheduled as depicted in FIG. 2a-FIG. 2m;

FIG. 4 is a schematic representation of a computer;

FIG. 5 is a schematic representation of a memory block within a CPU; and

FIG. 6 is a flow chart showing the implementation of the algorithm of FIG. 2.

### DESCRIPTION OF THE PREFFERED EMBODIMENTS

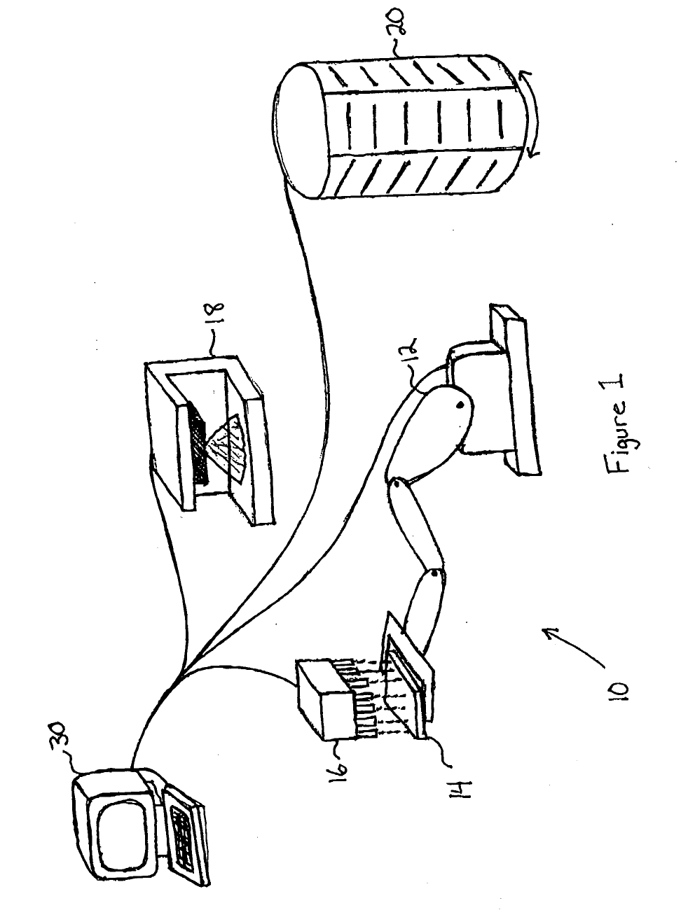

Reference is first made to FIG. 1, which is a schematic representation of a typical laboratory system 10. The laboratory system 10 includes a robotic device 12 capable of gripping a container 14 and moving the container 14 to various instruments within the system 10. The laboratory system 10 includes a dispensing apparatus 16, a scanning device 18 commonly referred to as a reader, and a carousel storage apparatus 20. The robotic device 12, dispensing apparatus 16 and the reader 18 are classified as resources needed by the system 10 to perform its desired tasks. The carousel 20 is classified as an object required in order to complete a cycle of the system 10. The carousel is also a resource. As it is required to store containers, each of its nest are treated as separate resources, each capable of storing a single container. Each of the resources is exemplary of the equipment that may be utilised to perform a sequence of operations on the container 14.

For the purpose of illustration, the steps performed by the system include: load carousel (i.e. operator places container in carousel, this is an initial condition); dispense a fluid from apparatus 16 to the container 14; read the contents of the container with the scanner 18; repeat the dispense from apparatus 16;. repeat the read using scanner 18; and load carousel. Each of the read and dispense steps include within their operation a “get” and a “put” operation. These get and put operations represent the retrieval and movement, respectively, of the sample container 14 using the robotic device. This sequence is to be repeated on a number of different samples using the same apparatus.

To avoid a logjam whilst obtaining enhanced utilisation of the resources, it is necessary to schedule the steps.

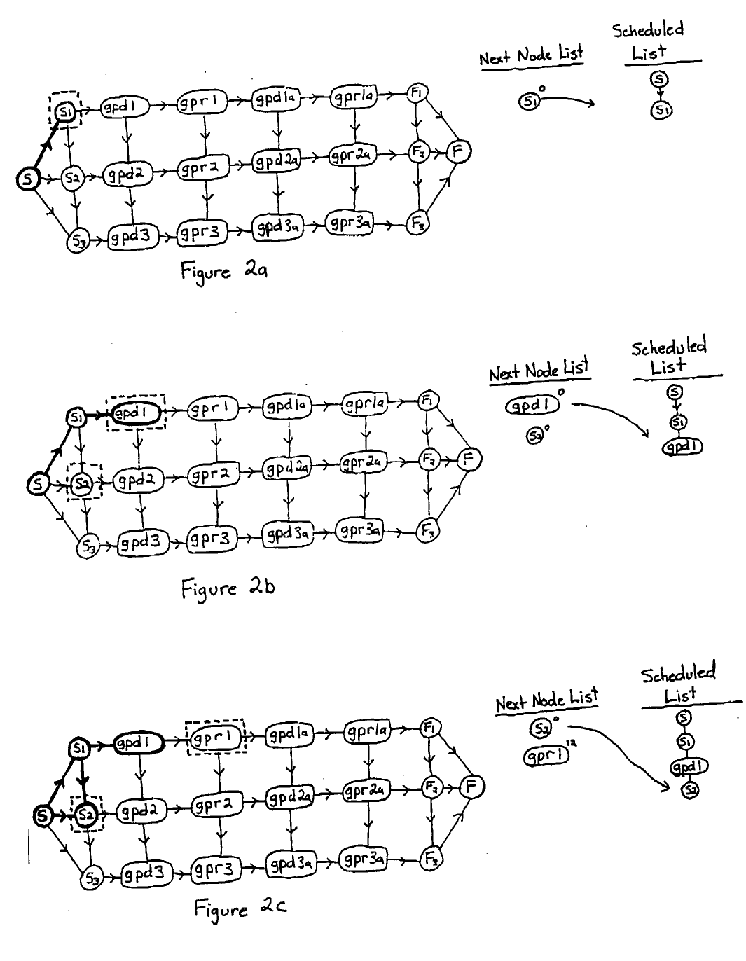

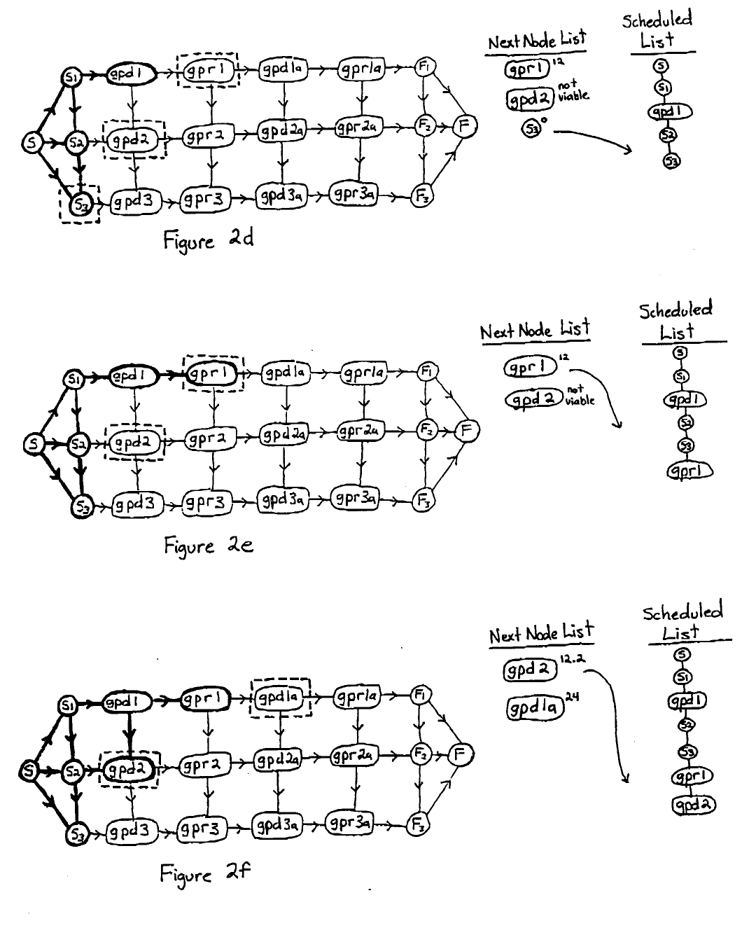

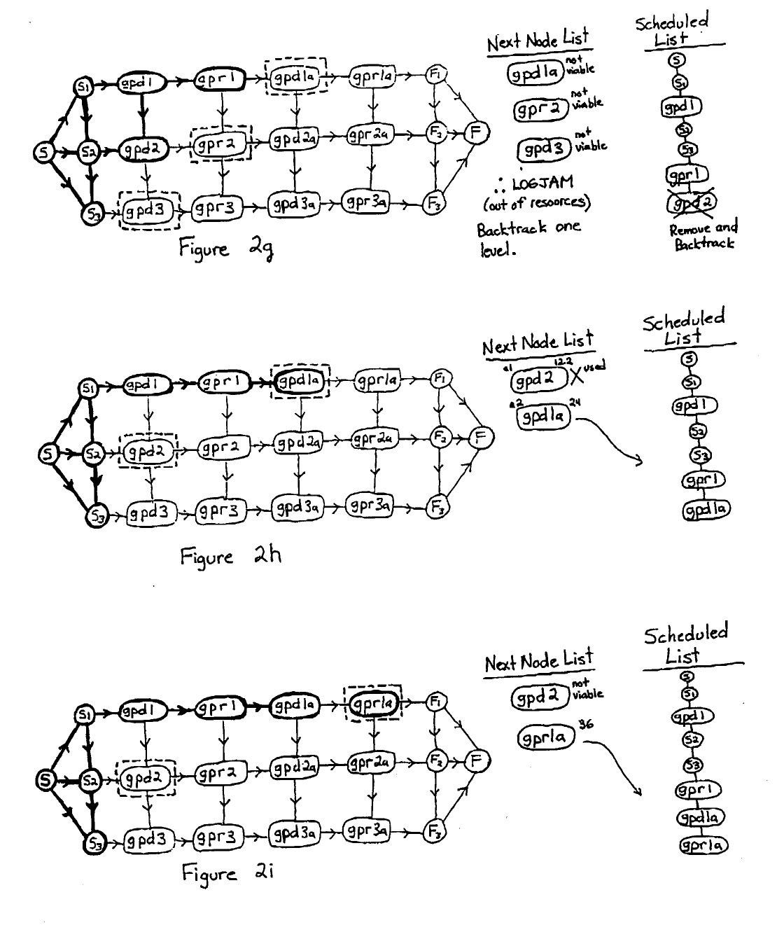

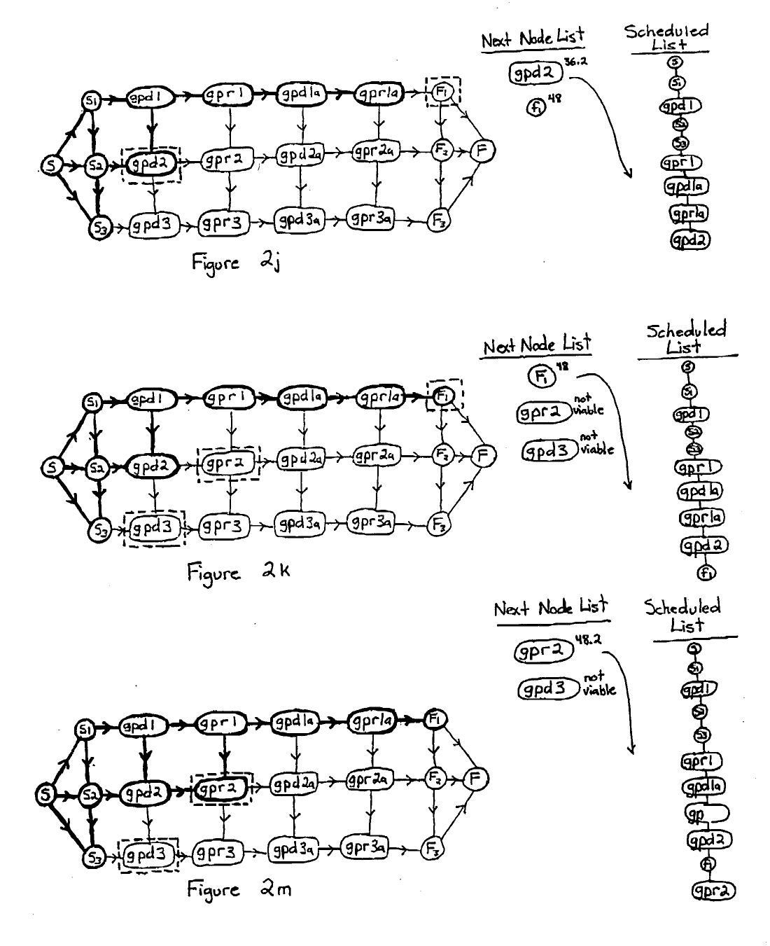

Reference is next made to FIG. 2a through FIG. 2m, which are a series of task graphs depicting the progression of the scheduling algorithm. The task graph consists of a series of nodes each of which represents a step comprising either a single task or set of tasks in the sequence requiring resources from the system depending on the nature of the step to be performed. The task graph represents the processing of 3 samples. Each of the nodes in this preferred embodiment represent either a load carousel, read, or dispense task together with their associated get and put operations.

The nodes are connected by directed edges that define a hierarchy within the tasks so that for example a read task of sample 1 is not done until a dispense task on sample 1 is complete. The node labelled with an “S” and the node labelled with an “F” represent the start and finish operations of the system respectively. The subset of these nodes, for example “S1” or “F1”, represents a load carousel task that positions the carousel for sample 1 to enter or leave the system respectively. Nodes labelled “gpd*” represent a “get-put-dispense task” in which the particular sample represented by the “*” is retrieved by the robotic device, placed in the dispenser apparatus and the dispense operation is performed. Nodes labelled “gpr*” represent a get-put-read task in which the particular sample represented by the “*” is retrieved by the robotic device, placed in the reader scanning device and a read of the sample is performed.

Each node within the task graph contains with it a number of operations. A node requires that the operations defining the task be accomplished. Each operation has attributes that indicate which resources it requires, the duration for which these resources are required and the time, relative to the start of the node, at which the operation should start. A node also requires a sample id that assigns the task associated with the node to a particular sample in the procedure. Furthermore, a node requires attributes that can store a score assigned to that node, the type of score (e.g. viable, not viable, never viable), as well as an index necessary for backtracking. The index identifies on which attempt the node was executed in the algorithm upon backtracking.

The task graph described above is used to create two lists. These lists are the “next nodes” list and the “scheduled nodes” list. The next nodes list is a dynamically updated list that includes any nodes that can be scheduled next. To be eligible for the next nodes list, a node must contain incoming edges that are directly connected to parent nodes that have already been scheduled. The scheduled nodes list contains the order in which the tasks will be performed while obeying the hierarchy of the task graph. Each addition to the scheduled nodes list originates from the next nodes list and is determined by scores associated with each node and indicated by the suffix adjacent the node in the next node list. The scores are indicative of a relative priority to be accorded to the nodes in the next nodes list and may be accorded by evaluation of a set predetermined criteria.

A score is computed for each node in the task graph. Each operation has a set of resource requirements (e.g. a nest position on a carousel and a robotic arm). The score computed is the earliest time at which the task node can start executing the operations so that each operation will have the required resources available. Thus if a node in the next node list requires the dispenser's resources and the node in the scheduled list is using the dispenser, the earliest time it becomes available is after dispensing and the score representing that time is accorded. If the previous node does not require the dispenser the resource is immediately available and an appropriate score is accorded.

In some cases a node being scored is not eligible for scheduling. This is handled by assigning a score type. A node that can be assigned a score is of the type “viable”. A node that is not eligible for scheduling is either named “not viable” or “never viable”. “Not viable” is the case where the resource requirements do not permit a score to be assessed at this moment but may be assessed later. “Never viable” is a special case that occurs when a task cannot be done because for example a maximum amount of waiting period has elapsed, called the max slip time. This is common if for example, a sample is left to incubate too long and therefore the sample cannot be processed any further. If all nodes in the next nodes list are classed as not viable or never viable, a backtrack is triggered as the system cannot proceed any further with the resources given.

The node is also accorded an index which is incremented upon return of the node to the next nodes list from the schedule during a backtrack operation.

The start procedure node is scheduled first because it has no parent nodes. As shown in FIG. 2a, once the start procedure node is scheduled the only node with all parent nodes scheduled is the S1 node encased in a dashed box. This node becomes part of the next nodes list. This node has a score of 0 as it is available immediately. This node now becomes scheduled after the start procedure node. The scheduled nodes are highlighted in the task graph.

The next iteration of the algorithm is shown in FIG. 2b. There now exists two nodes that have all parent nodes already scheduled which are the gpd1 and the S2 nodes. Both of these nodes contain a score of 0 because they are both available immediately. The gpd1 node is chosen to be scheduled next through a non-random tie-breaking procedure.

When two nodes have the same start time or score, one is chosen over the other by examining a set of predetermined scoring criteria. Viable ranks ahead of not viable and as mentioned earlier, if only not viable exists, backtracking is triggered. When dealing with two similar start times, the tie is broken by an additional indicator, typically a sample node id. Therefore, in the event of a tie, a task involving sample 1 would precede a task in sample 2. Further to this, a task node id is used to ensure the algorithm proceeds in order of the steps in the sample if a tie occurs between two tasks assigned to the same sample. The S2 node thus remains a part of the next nodes list.

FIG. 2c illustrates a third iteration of the algorithm. With the addition of the gpd1 node, the next nodes list receives the gpr1 node because the gpd1 node is its only parent and has been scheduled. The next nodes list now contains the S2 node with a score of 0 and the gpr1 node with a score of 12. The gpr1 node has a score of 12 because sample 1 will not be available until the 12 seconds required to dispense has elapsed. From these scores, S2 is scheduled next.

A fourth iteration of the algorithm is shown in FIG. 2d. The next nodes list now contains three nodes. The gpr1 remains with a score of 12 unchanged because the addition of S2 to the scheduled list does not increase the dependency for any resources required by gpr1. It's still limited by the time taken for gpd1 to be completed, i.e. it cannot be read until dispensing is complete. The two new nodes are gpd2 node with a score of “not viable” and the S3 node with a score of 0. The gpd2 node is given a score of not viable and thus passed over because the resource required is the dispenser. Sample 1 is in the dispenser at this point in the schedule but its removal has not yet been scheduled. Accordingly the availability of the dispenser is indeterminate. The latter of the two new nodes can be done immediately therefore the next scheduled node is S3.

Reference is now made to FIG. 2e, which is a fifth iteration of the algorithm. The scheduling of S3 creates no new nodes to be added to the next nodes list. The next nodes list now contains the gpr1 and gpd2 nodes. The gpr1 node remains scored as 12 and the gpd2 node remains not viable because sample 1 is still currently in the dispenser. The gpr1 node is chosen to be scheduled next and consequently the gpd1a node (second dispense of sample 1) can be added to the next nodes list.

As seen in FIG. 2f, the next nodes list contains the gpd2 and gpd1a nodes. This iteration of the algorithm re-scores the gpd2 node as 12.2. This score is given because at 12 seconds the robotic device will move sample 1 to the reader and the dispenser becomes free but sample 2 is not available to be placed in the dispenser until the robotic device is available following the get and the put of sample 1 to the reader. The gpd1a node is scored 24 because sample 2 will not be available until the additional 12 seconds to read the sample is complete. Using these scores, the gpd2 node is scheduled and consequently, the gpr2 and gpd3 nodes can be added to the next nodes list.

With reference to FIG. 2g, the next nodes list now contains the gpr2 and gpd3 nodes in addition to the gpd1a node. Following a resource allocation check, each of the three nodes in the next nodes list is given a score of not viable. This occurs because sample 1 must be placed back in the dispenser and sample 2 would now need to go from the dispenser to the reader. However with only one robotic device, neither of these tasks can be accomplished. The gpd3 node is not viable for the same reason, in that sample 2 would already be occupying the dispenser. This condition is known as a logjam and causes a disruption in the process as it is now impossible to proceed. To deal with this situation backtracking is done.

Backtracking is a method that when the algorithm encounters a situation wherein the process can not proceed, it unwinds to the previous execution and chooses a different path. This different path is chosen as the next best score of nodes in the next nodes list at that point in the scheduling process. As seen in FIG. 2g, the gpd2 node will be unscheduled and the scheduling procedure backtracks to the situation depicted in FIG. 2f.

Now giving reference to FIG. 2h, the algorithm has backtracked to give a next node list containing gpd2 and gpd1a as seen in FIG. 2f. The choice of gpd2 that was previously chosen and resulted in the logjam is marked as previously used. The gpd1a node is a viable selection and therefore is scheduled in place of the previous choice of node gpd2. The new selection is indexed as 2. This indicates that the encountered node in the schedule was the second choice following a backtracking procedure.

A ninth iteration of the algorithm is shown in FIG. 2i. The next nodes list now contains the gpd2 and pgr1a (second read of sample 1) nodes. These nodes are scored and the gpd2 node is scored as “not viable” because the dispenser is occupied by sample 1. The gpr1a node is given a score of 36. A score of 36 means that this task is available to run after the 3 previous 12 second tasks performed on sample 1. The gpr1a node is placed next on the scheduled list.

Referring to FIG. 2j, which is a tenth iteration of the algorithm, at this iteration, the next nodes list contains the gpd2 node as before and now contains the f1 node. The scoring procedure gives gpd2 a score of 36.2 and the f1 node a score of 48. The 36.2 score is given because sample 2 can be placed in the dispenser once sample 1 is placed in the reader for the second time which can commence after 36 seconds and the 2/10 of a second represents the time for the robotic device to retrieve sample 2 from the dispenser and place it in the reader. The f1 node is available upon completion of the 4 previous 12 second tasks to be performed on sample 1. Using these scores, the gpd2 node is scheduled next.

In reference to FIG. 2k, the next nodes list now contains the f1 node as before as well as the gpr2 and gpd3 nodes. The f1 node retains the score of 48 and the other two nodes are scored as not viable as both the dispenser and the reader are occupied with sample 1 and sample 2. With these scores, the algorithm schedules the f1 node next. This will finish the procedure for sample 1 by loading it back into the carousel.

FIG. 2m illustrates a twelfth iteration of the algorithm. In this iteration, the next nodes list contains the gpr2 and gpd3 nodes as before. Upon scoring these nodes, the gpr2 node now is given a score of 48.2 and the gpd3 node is scored “not viable”. The score of 48.2 is given because sample 2 is available to be placed in the reader once sample 1 is removed and the first dispense of sample 2 is complete which is 12 seconds beyond its time of placement being at 36.2 seconds. At this point an overlap of tasks being performed on sample 1 and sample 2 has occurred. The gpd3 node is not viable because the dispenser is not free and therefore the gpr2 node is scheduled next.

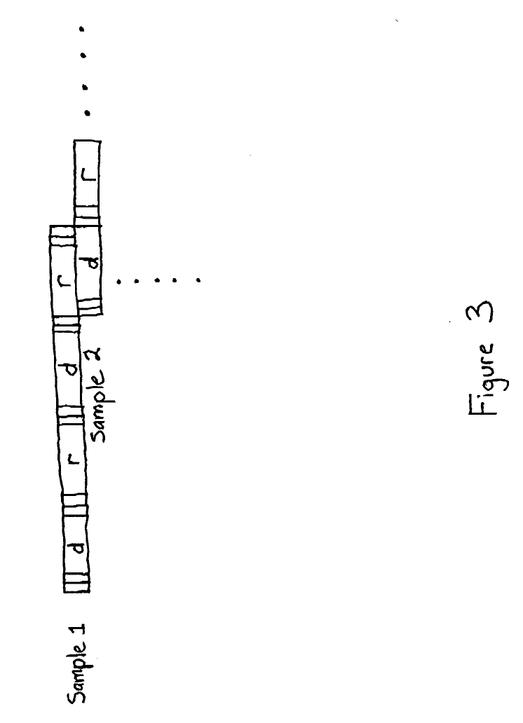

At this point in the procedure, the algorithm's scheduling process is believed to be evident and it will be understood that further iterations of the algorithm will repeat as detailed above for the remaining samples to be processed. It will be seen therefore that the scheduling algorithm is effective to resolve logjams and ensure an orderly scheduling of tasks performed by the apparatus of FIG. 1. The scheduling also permits reduction in the run time of the apparatus to improve efficiency and throughput, as may be seen from FIG. 3, which is a graphical Gantt style chart. This chart shows a sequence of events represented by bars of different length. Each bar represents an operation belonging to a node on the task chart and each sequence represents the processing cycle of one sample. The overlap of tasks for sample 1 and sample 2 can be seen from this figure. The overlap is due to the scheduling of resources wherein time is conserved. An extrapolation of this chart would conveniently show the amount of time that can be saved if many samples are to be processed in sequence.

In order to effect control of the apparatus of FIG. 1, the algorithm described above is implemented using a computer that is programmed or configured using a set of program instructions contained on a computer readable medium, such as a CD ROM, magnetic discs or tape, semi conductor memory such as PCMIA cards or RAM. The computer has a control output to respective ones of the resources of FIG. 1 to control the devices in the sequence determined by the algorithm.

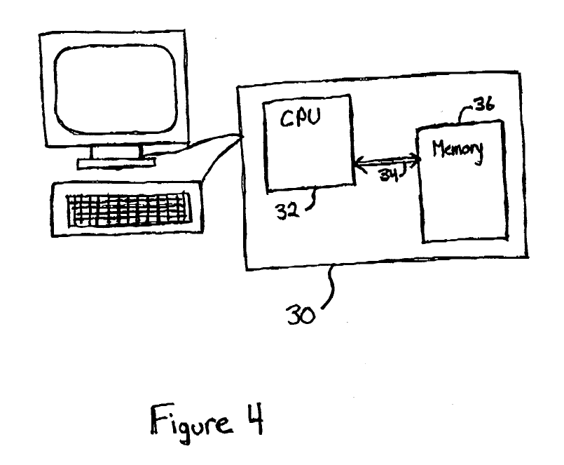

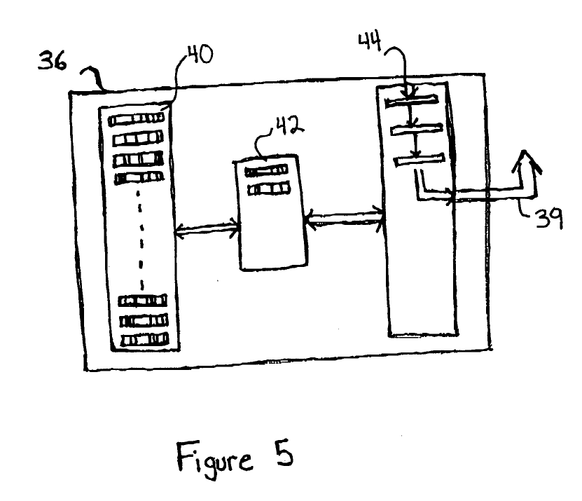

A method of performing a sequence of scheduling steps in which a computer shown schematically in FIG. 4, would execute in software code will now be described. As may be seen in FIG. 4, the computer 30 includes a CPU 32 to execute program instructions read and stored from the medium 34. A memory 36 retains data generated during operation of the algorithm for subsequent retrieval.

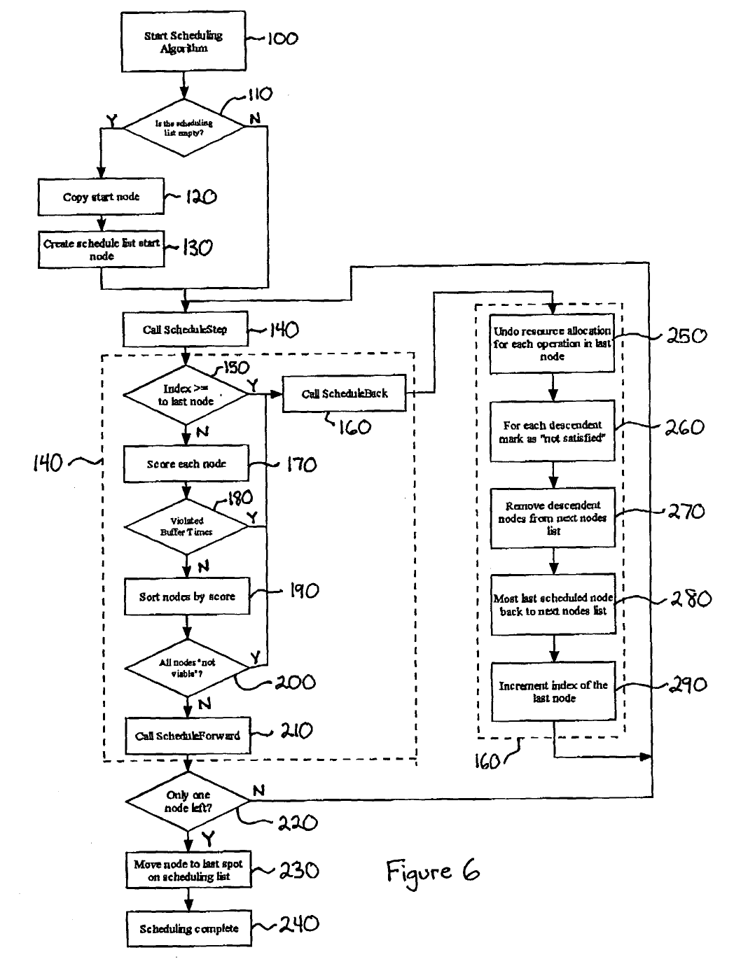

Reference will now be made to FIG. 5, which is a schematic representation of a memory 36 as seen in FIG. 4. A memory 36 is used by the scheduling algorithm to store task information as a node. Based on the node's attributes, the memory will store lists of nodes that the scheduling algorithm uses to build the desired schedule. A block within the memory 36 holds an entire set of task nodes defining a task graph. Each node within this set has associated with it a number of attributes that further define the node. The program executed by the CPU assigns each node a task identifier, address and a set of pointers that represent outgoing edges in a task graph that point to the child nodes of that particular node as well as a set of pointers representing incoming edges from other nodes. Each node also has within itself, a storage area for node attributes assigned while the algorithm is being executed such as its score. The program creates a node for each task in the task graph and loads these nodes into the task graph block 40 in a hierarchical order to reduce scan time of the list.

Once the task graph block is complete with its list of task nodes, the program begins its scheduling algorithm. The list is scanned to determine the nodes that have no pointers that indicate incoming edges. If one exists, a copy of the node and its data is made and placed in the next nodes list 42. If only one “viable” node exists in the next nodes list that node data is automatically transferred to the scheduled node block 44 that implements a first-in-first-out (FIFO) data structure so this first data transferred to the block 44 becomes the first data implemented in the schedule. The program executes a loop to begin the next iteration of the algorithm. The data stored within the task graph block 40 is updated so that the pointers of incoming edges that originated from the node just scheduled are labelled “satisfied” to indicate that that particular parent node has been scheduled. The node just scheduled is inspected to determine which of its child nodes have all of their parent edges labelled “satisfied” and a copy of these nodes is transferred to the next nodes memory block 44 for the algorithm to perform its scoring operation. As explained above with reference to FIG. 2, the node with the lowest score and obeying the tie-breaking rules will be transferred to the scheduled list memory block. The memory blocks within the memory are scanned and data is copied and transferred in this way until the data within the next nodes list block 44 is detected as a logjam. The detection and correction of a logjam is explained in detail with reference to FIG. 6, which is a flowchart describing the pseudo-code given below.

The algorithm functions are represented in a flow chart shown in FIG. 6. The control and decision structures refer to the lists stored in memory 36 as explained above. The schedule begins operation 100, if the schedule list is empty 110 a copy of the start node from the nodes list is made 120 and this copy is used to create a start node in the scheduled nodes list 130. If the scheduled list is not empty, the schedulestep routine 140 is called. The schedulestep routine begins by checking if the index of the last node in the scheduled nodes is greater than or equal to the number of nodes in the next nodes list 150. If this is correct all of the possible next nodes have been tried and the scheduleback routine 160 is called which backtracks the schedule to resolve a logjam as will be explained later. If this is not correct, each node in the next nodes list is scored 170 and a check is done if the ancestor buffer times of the nodes is violated 180. This is known as the max slip time as explained above. If even one of the nodes meet this criteria, the scheduleback routine 160 is called. If this is not true the nodes are sorted by score 190 and if there exists no viable nodes 200 the scheduleback routine 160 is called. If there exists at least one viable node, the scheduleforward routine 210 is called to add a node to the scheduled nodes list. This routine can be referenced in the pseudo-code and performs the normal scheduling of nodes as explained in full detail above. Once the scheduleforward routine 210 has been executed, if the there exists only one remaining node in the list 220 that node is moved to the scheduled nodes list 230 and the schedule is complete 240. If there exists more than one node in the list, the algorithm loops back to begin another iteration.

As mentioned, the algorithm detects logjams as represented in FIG. 2g and calls the scheduleback routine 160 in this situation. The scheduleback routine 160 begins by undoing the resource allocations for each operation of the last node scheduled in the scheduled nodes list 250. For each descendant of the last node in the scheduled nodes list, the node is marked as not satisfied 260 which labels the incoming edge pointers as “unsatisfied”. For each of the descendants, if the node is in the next nodes list it is removed 270. The last scheduled node in the scheduled nodes list is moved back into the next nodes list 280 and the index is incremented by one to show that it has been tried 290 and this ensures backtracking will not try this node again for this particular path. With the logjam resolved the normal scheduling resumes until a new logjam is detected.

The following pseudo-code describes the actions of the Scheduler when the Scheduler::Schedule method is invoked as described above and can be referenced in FIG. 6.

CScheduler::Schedule:

1. If the scheduled nodes list is empty,

1.1. Copy the start node from the task graph to the next nodes list.

1.2. Create a scheduled start node and place it in the scheduled nodes list. Set its next node index to zero.

2. Loop,

2.1. Call ScheduleStep to perform the next step in scheduling.

2.2. If there is only one node on the next nodes list and it is the end node,

2.2.1. Move it to the scheduled nodes list.

2.2.2. Scheduling completed, exit.

CScheduler::ScheduleStep:

1. If the index of the last node in the scheduled nodes is greater than or equal to the number of nodes in the next nodes list (i.e., all of the possible next nodes have been tried),

1.1. Call ScheduleBack.

1.2. Exit the method.

2. For each node in the next nodes list,

2.1. Score the node by calling its ComputeScore( ) method (see description and pseudo-code in section.

2.2. If the score indicates that one of the node's ancestor's buffer times would be violated,

2.2.1. Call ScheduleBack.

2.2.2. Exit the method.

3. Sort the next nodes list by score.

4. If the node in the next nodes list that is identified by the index in the last node of the scheduled nodes list has a score that indicates that it is not viable,

4.1. Call ScheduleBack.

4.2. Exit the method.

5. Call ScheduleForward.

CScheduler::ScheduleForward:

1. Move the node in the next nodes list that is identified by the index in the last node of the scheduled nodes list to the end of the scheduled nodes list, thus removing it from the next nodes list, OR, if a task node is specified (rescheduling failure recovery), use that node instead.

2. Set the next node index of the last node in the scheduled nodes list to zero.

3. For each descendant node of the last node in the scheduled nodes list,

3.1. Mark the edge connecting the scheduled node to this descendant node as satisfied.

3.2. If all of the descendant node's ancestor's have been satisfied (i.e., the edges leading from all the descendant node's ancestor nodes have been marked as satisfied),

3.2.1. Add the node to the next nodes list.

4. For each operation of the newly scheduled node,

4.1. Allocate the resources required for the operation by calling its Schedule( ) method.

5. Mark all descendant node edges of the newly scheduled node as satisfied.

CScheduler::ScheduleBackward:

1. For each operation of the last node in the scheduled nodes list,

1.1. Undo resource allocations for the operation.

2. For each descendant of the last node in the scheduled nodes list,

2.1. Mark the node as not satisfied.

2.2. Remove the node from the next nodes list if it is there.

3. Move the last node in the scheduled nodes list back into the next nodes list.

4. Increment the index of the last node in the scheduled nodes list. Note that this may push the index beyond the end of the list, indicating that all possible next nodes have been tried.

According to FIG. 2h, the next available node once the gpd2 node is removed from the scheduled list is the gpd1 a node. It is detected by the processor and rescheduled as the next scheduled node by the above described method in reference to FIG. 6.

Upon completion of the routine, a schedule is complete which is used to output control functions through a control bus 39 to the system 20. The scheduling algorithm has inherent flexibility allowing it to be adapted to number of different situations. For example, the scheduler algorithm can have in its implementation the ability to combine or separate pairs of containers. Referring to FIG. 1, in which a laboratory system includes samples held in containers, these container may have lids that can be removed from the container. In this case the laboratory system would have added resources and nodes associated with the capabilities of lid removal. Once a container and its lid have been separated, they can follow distinct paths through the system. These attributes can be programmed to be associated with a particular node as seen in the various steps of FIG. 2a to FIG. 2m.

Within the implementation of the algorithm, the scheduling problem is presented to the scheduler in an XML string format, although it could be presented in any format that could be converted, programmatically into the internal data structures used by the algorithm. In reference to FIG. 4 and FIG. 5, the computer will store the data structures and use them in a similar way, however the format can be different as the ability to convert these data structures permits. When applied to a laboratory application as seen in FIG. 1, this format will include a list of containers, instrument nests where these containers may be stored, robotic devices for moving the containers, and a task graph that represents these lists using a collection of nodes. The graph consists of defined start and end nodes and edges connecting these nodes as seen in detail from FIG. 2a to FIG. 2m.

Giving reference to FIG. 6, the user of the algorithm has the ability to instruct the scheduler to save a partially completed run. This can be done at any point shown in the flowchart of FIG. 6. The remaining nodes, which have not completed executing on the system, are saved in a “Checkpoint” file within the memory 36 shown in FIG. 5. This file can be reloaded later, for the purpose of rescheduling and resuming the interrupted run. Further to this, the algorithm allows the user to modify the remaining steps in an interrupted run. This can be used to instruct the system to dispose of samples that may have been spoiled during the interruption. Giving reference to FIG. 2g in which a logjam was detected. At this point if the max slip time of a sample has caused a “never viable” identity to a node, the user can instruct a removal of the node resulting in a rescheduling of the nodes not scheduled from the task graph. This will dynamically change the structure of the task graph and allow the user to deal with interruptions in the system. Similarly, further to the above feature, a user has the capability of adding tasks to the schedule during operation. The scheduling algorithm can dynamically insert these tasks as nodes and the algorithm continues from the interrupted point and reschedules as seen before in FIG. 2a to FIG. 2m.

In the scheduling algorithm, the scoring attributes provide an ordered structure that permits a respective set of steps to be performed. In addition, the indexing of the nodes provides a mechanism to resolve a logjam through back tracking and adoption of alternative schedules. The scoring and indexing are applied dynamically as the task graph is changed and thereby provide an inherently flexible scheduling algorithm.

Whilst, the algorithm has been described with reference to the system 10, it will be appreciated that it is applicable to other environments where tasks are to be scheduled.

1. A method of scheduling a plurality of tasks comprising the steps of establishing a node representative of each task, and indicative of resources required to perform that task, establishing a hierarchy between said nodes to indicate an order in which tasks represented by said nodes are to be performed, selecting from said nodes those whose hierarchy permits tasks represented by said node to be performed, assigning to each of said selected nodes a score indicative of a priority to be accorded to respective ones of said selected nodes and scheduling a node with the highest priority.

2. A method according to claim 1 wherein said selected nodes include an index indicative of a prior selection of said node to a schedule.

3. A method according to claim 1 wherein said score includes an indication of viability of performing tasks represented by said node and said viability is polled to indicate a logjam upon none of said selected nodes being viable.

4. A method according to claim 3 wherein a previously selected node resulting in a logjam is indexed to inhibit its subsequent selection in said schedule.
